(19) United States
(12) Patent Application Publication
(10) Pub. No.: US 2013/0207448 A1
(43) Pub. Date: Aug. 15, 2013

(54) FORCE DISTRIBUTING APPARATUS FOR A BICYCLE WHEEL SPOKE

(71) Applicants: Kazuki Koshiyama, Izumiotsu (JP); Hiroshi Fujita, Matsubara (JP)

(72) Inventors: Kazuki Koshiyama, Izumiotsu (JP); Hiroshi Fujita, Matsubara (JP)

(73) Assignee: SHIMANO, INC., Sakai City (JP)

(21) Appl. No.: 13/369,489

(22) Filed: Feb. 9, 2012

(51) Int. Cl. B60B 1/04

(52) U.S. Cl. 301/59

(57) ABSTRACT

A force-distributing apparatus for a bicycle wheel spoke includes a force-distributing body having a free-end first surface and a second surface disposed at an opposite side of the first surface. The first surface substantially has the shape of a truncated sphere, and the force-distributing body has a spoke-receiving opening that extends through the first surface.

### BACKGROUND OF THE INVENTION

The present invention is directed to bicycle wheels and, more particularly, to a force-distributing apparatus for a bicycle wheel spoke.

A typical bicycle wheel comprises a hub that is rotatably mounted around a hub shaft, an annular rim structured to support a tire, and a plurality of spokes that connect the hub to the rim. The hub typically includes a pair of spaced-apart hub flanges, wherein each hub flange includes a plurality of circumferentially-disposed openings. The wheel rim also includes a plurality of circumferentially-disposed openings. Each spoke typically has an enlarged head at one end and a threaded shaft at the other end. The spoke extends through a corresponding opening in one of the hub flanges and through a corresponding opening in the wheel rim until the head abuts against the hub flange. The spoke is fastened to the wheel rim by a threaded nut that is screwed onto the threaded shaft and abuts against the wheel rim.

### SUMMARY OF THE INVENTION

The present invention is directed to various features of a force-distributing apparatus for a bicycle wheel spoke. In one embodiment, a force-distributing apparatus for a bicycle wheel spoke comprises a force-distributing body having a free-end first surface and a second surface disposed at an opposite side of the first surface. The first surface substantially has the shape of a truncated sphere, and the force-distributing body has a spoke-receiving opening that extends through the first surface.

In another embodiment, a force-distributing apparatus is provided for a bicycle wheel spoke, wherein the spoke is structured to be mounted to a hub flange of the bicycle wheel, and wherein the hub flange includes an opening with a flange opening axis. The apparatus comprises a force-distributing body including a free-end first surface, a second surface disposed at an opposite side of the first surface, and a spoke-receiving opening. The first surface of the force-distributing body is structured to engage the hub flange when the spoke is mounted to the hub flange, and at least one of the first surface or the second surface is shaped to allow the spoke to move in any lateral direction relative to the flange opening axis.

Additional inventive features will become apparent from the description below, and such features alone or in combination with the above features and their equivalents may form the basis of further inventions as recited in the claims.

### BRIEF DESCRIPTION OF THE DRAWINGS

FIG. 1 is a perspective view of a particular embodiment of a bicycle wheel hub with a spoke and a force-distributing apparatus mounted to a hub flange in a rest position;

FIG. 2 is a more detailed perspective view showing the relationship of the hub flange, the spoke, and the force-distributing apparatus;

FIG. 3A is a front perspective view of the force-distributing apparatus;

FIG. 3B is a rear perspective view of the force-distributing apparatus;

FIG. 4 is a perspective view of another embodiment of a force-distributing apparatus;

FIG. 5 is a view taken along line 5-5 in FIG. 4;

FIG. 6 is a side view showing a plurality of spokes mounted to a hub flange of the bicycle wheel hub using the alternative force-distributing apparatus shown in FIGS. 4 and 5;

FIG. 7A is a front perspective view of an alternative embodiment of a force-distributing apparatus;

FIG. 7B is a rear perspective view of another alternative embodiment of a force-distributing apparatus; and

FIG. 8 is a cross-sectional view, similar to FIG. 5, of another alternative embodiment of a force-distributing apparatus.

### DETAILED DESCRIPTION OF THE EMBODIMENTS

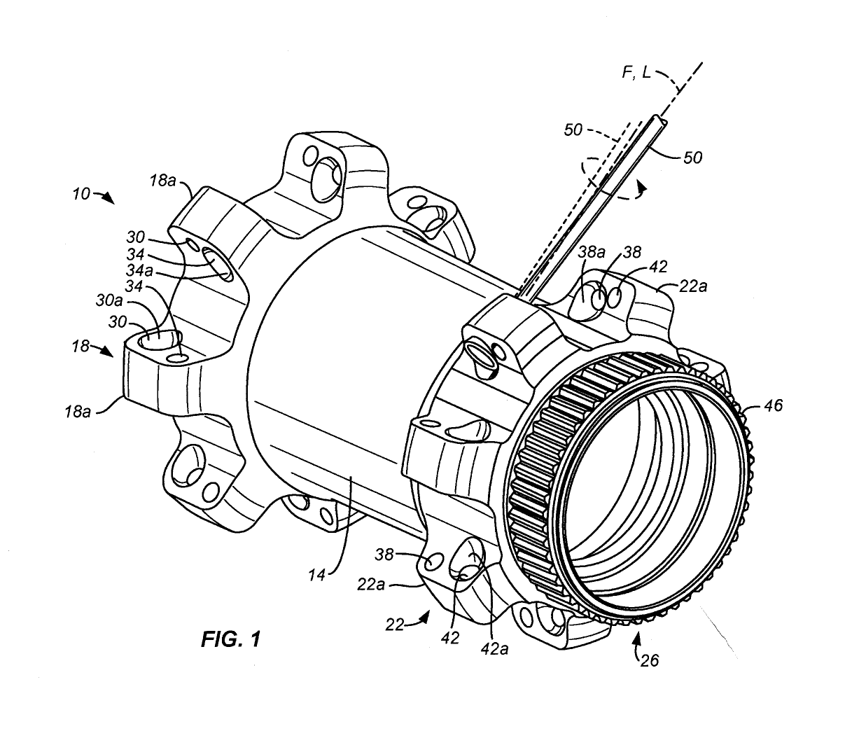

FIG. 1 is a perspective view of a bicycle wheel hub 10 that comprises a hollow hub body 14, a first hub flange unit 18, a second hub flange unit 22, and a brake rotor fixing unit 26. First hub flange unit 18 includes a plurality of circumferentially-disposed and radially-extending hub flanges 18a, each of which has a first spoke-mounting opening 30 and a second spoke-mounting opening 34. Each first spoke-mounting opening 30 includes a clockwise-facing contact surface 30a, and each second spoke-mounting opening 34 includes a counterclockwise-facing contact surface 34a. Similarly, second hub flange unit 22 includes a plurality of circumferentially-disposed and radially-extending hub flanges 22a, each of which has a first spoke-mounting opening 38 and a second spoke-mounting opening 42. Each first spoke-mounting opening 38 includes a counterclockwise-facing contact surface 38a, and each second spoke-mounting opening 42 includes a clockwise-facing contact surface 42a. Brake rotor fixing unit 26 comprises a plurality of circumferentially-disposed splines 46 that are used to mount a conventional disk brake rotor.

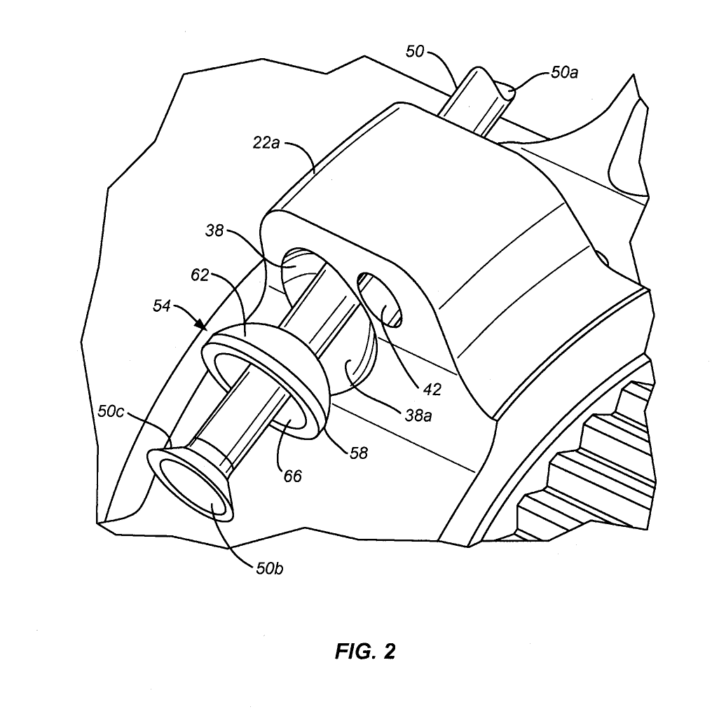

FIG. 1 shows a spoke 50 mounted to hub flange 22 in a rest position. As shown in FIG. 2, spoke 50 includes an elongated spoke body 50a and a spoke head 50b, wherein spoke body 50a extends through first opening 38 in hub flange 22a. In this embodiment, spoke head 50b includes a contact surface 50c in the form of a frustum of a hemisphere. A force-distributing apparatus in the form of a force-distributing member 54 is disposed between contact surface 38a of hub flange 22a and contact surface 50c of spoke 50.

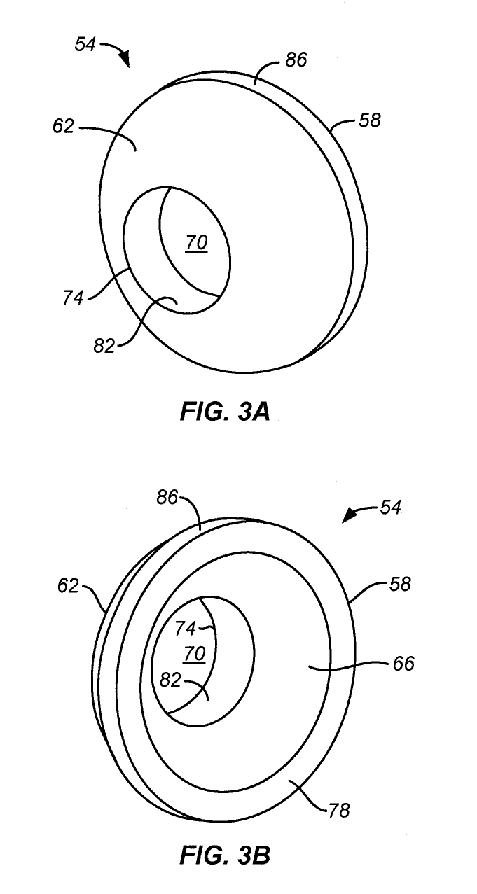

As shown in FIGS. 3a and 3b, force-distributing member 54 includes a force-distributing body 58 that has the shape of a truncated sphere. As used herein, the phrase “shape of a truncated sphere” applies to “generally has the shape of a truncated sphere,” such as generally the shape of a hemisphere, such as generally the shape of a frustum of a sphere, such as generally the shape of a frustum of a hemisphere, such as generally the shape of a frustum of a hollow hemisphere, and optionally a true frustum of a hollow hemisphere. The word “sphere,” applied to a hollow or solid, convex or concave object, has the ordinary definition of a three-dimensional surface, all points of which are equidistant from a fixed point. The word “truncated” in the context of a geometrical object has the ordinary meaning of having the apex cut off, preferably but not necessarily by a plane.

Force-distributing body 58 has a convex free-end first surface 62, a concave second surface 66 disposed at an opposite side of first surface 62, and a centrally-disposed spoke-receiving opening 70 that extends through first surface 62 and second surface 66. A circular front edge 74 is formed at the junction of first surface 62 and spoke-receiving opening 70, and an annular rear edge 78 is formed at the rear of force-distributing body 58. A cylindrical inner transition surface 82 is formed between front edge 74 and second surface 66, and a cylindrical outer transition surface 86 is formed between first surface 62 and rear edge 78. As a result of the foregoing structures, first surface 62 and second surface 66 each generally has the shape of a truncated sphere, such as generally the shape of a hemisphere, such as generally the shape of a frustum of a sphere, such as generally the shape of a frustum of a hemisphere, and optionally a true frustum of a hemisphere.

As shown in FIGS. 1 and 2, first surface 62 of force-distributing member 54 is structured to engage contact surface 38a of first spoke-mounting opening 38 in hub flange 22a, and second surface 66 of force-distributing member 54 is structured to engage contact surface 50c of spoke head 50b. The same is true when spokes 50 are mounted in openings 30 and 34 in hub flanges 18a and in the other openings 38 and 42 in hub flanges 22a. The portion of each contact surface 30a, 34a, 38a and 42a that engages first surface 62 of a corresponding force-distributing member 54 generally has the shape of a truncated sphere, such as generally the shape of a hemisphere, such as generally the shape of a frustum of a sphere, such as generally the shape of a frustum of a hemisphere, and optionally a true frustum of a hemisphere.

When spoke 50 is mounted to hub flange 22a in the rest position shown in FIG. 1, spoke 50 defines a longitudinal rest-position axis L that aligns with a flange opening axis F. Contact surface 38a of first spoke-mounting opening 38 and first surface 62 of force-distributing member 54 form a ball joint when spoke 50 is mounted to hub flange 22a. As a result, spoke 50 can be mounted at any angle relative to hub flange 22a. Furthermore, spoke 50 can gyrate or otherwise move in any direction relative to axes F and L as shown by broken lines in FIG. 1. In this embodiment, contact surface 50c of spoke head 50a and second surface 66 of force-distributing member 54 also form a ball joint when spoke 50 is mounted to hub flange 22a so that spoke 50 can gyrate or otherwise move in any direction relative to axes F and L. The same is true when spokes 50 are mounted in openings 30 and 34 in hub flanges 18a and in the other openings 38 and 42 in hub flanges 22a. As a result, hub flanges 18a and 22a can accommodate any motion of spokes 50 caused by lateral forces applied to the wheel rim, thereby avoiding undesirable stresses to spokes 50 during operation of the bicycle.

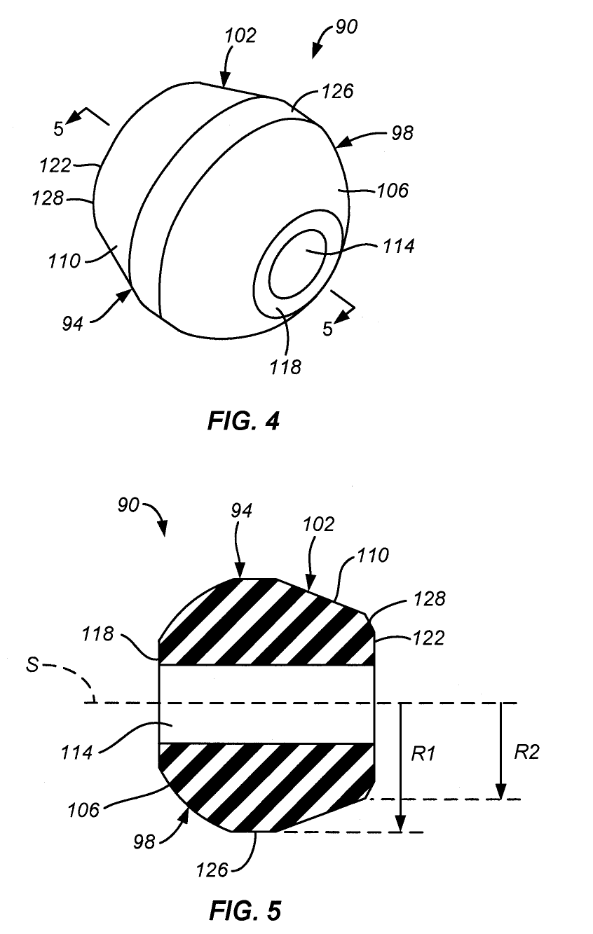

FIG. 4 is a perspective view of another embodiment of a force-distributing apparatus in the form of a force-distributing member 90, and FIG. 5 is a cross-sectional view taken along line 5-5 in FIG. 4. In this embodiment, force-distributing member 90 comprises a force-distributing body 94 including a first portion 98 and a second portion 102. A convex first surface 106 is disposed on first portion 98, a second surface 110 is disposed on second portion 102, and a spoke-receiving opening 114 extends through first portion 98 and second portion 102 to form a spoke-receiving axis S (FIG. 5). An annular front edge 118 is formed at the front of force-distributing body 94, and an annular rear edge 122 is formed at the rear of force-distributing body 94. A generally cylindrical outer transition surface 126 is formed between first surface 106 and second surface 110, and an annular beveled surface 128 is formed between second surface 110 and rear edge 122. Second surface 110 is tapered relative to spoke-receiving axis S so that a radius R1 of second surface 110 at outer transition surface 126 is greater than a radius R2 of second surface 110 at beveled surface 128. In this embodiment, first surface 106 generally has the shape of a truncated sphere, such as generally the shape of a hemisphere, such as generally the shape of a frustum of a sphere, such as generally the shape of a frustum of a hemisphere, and optionally a true frustum of a hemisphere. Second surface 110 generally has a conical shape, such as generally the shape of a truncated cone, such as generally the shape of a frustum of a cone, and optionally a true frustum of a cone.

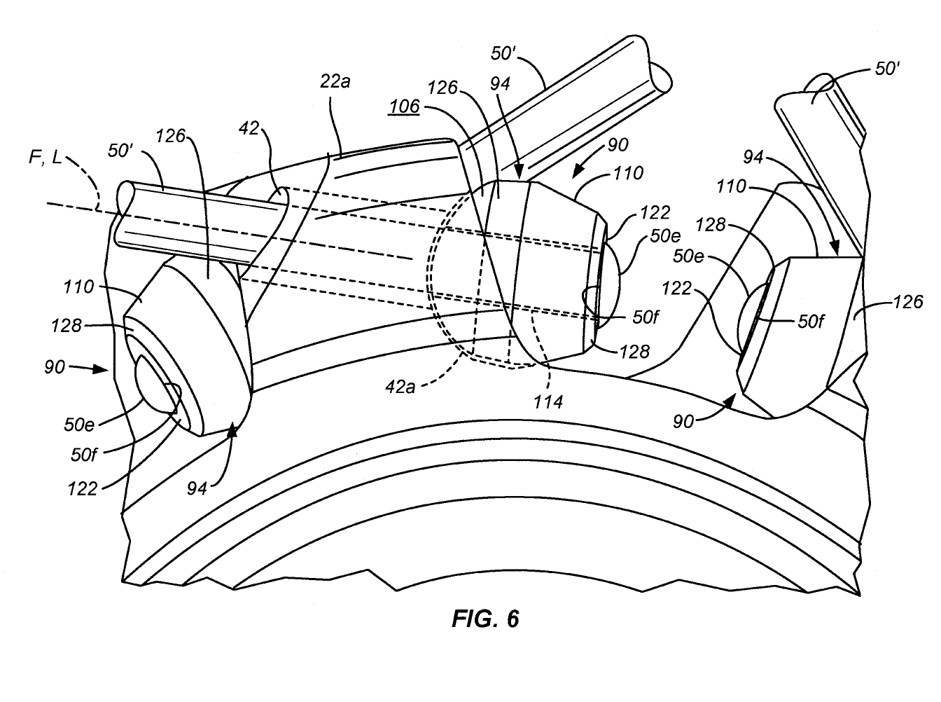

FIG. 6 is a side view showing a plurality of modified spokes 50′ mounted to hub flange 22a, for example, using force-distributing member 90. Each spoke 50′ has a modified spoke head 50e in the form of a hemisphere with a flat annular surface 50f that contacts rear edge 122 of a corresponding force-distributing member 90 when spoke 50′ is mounted to flange 22a.

Hub flanges 18a and 22a have the same structure as in the first embodiment. Thus, as shown in FIG. 6, as in the first embodiment, first surface 106 of each force-distributing member 90 is structured to engage a corresponding contact surface (e.g., contact surface 42a) of a spoke-mounting opening (e.g., second spoke-mounting opening 42). First surface 106 of force-distributing member 90 and contact surface 42a of second spoke-mounting opening 42 form a ball joint when spoke 50′ is mounted to hub flange 22a. As a result, as in the first embodiment, spoke 50′ can be mounted at any angle relative to hub flange 22a, and spoke 50′ can gyrate or otherwise move in any direction relative to axes F and L in response to lateral forces applied to the bicycle wheel.

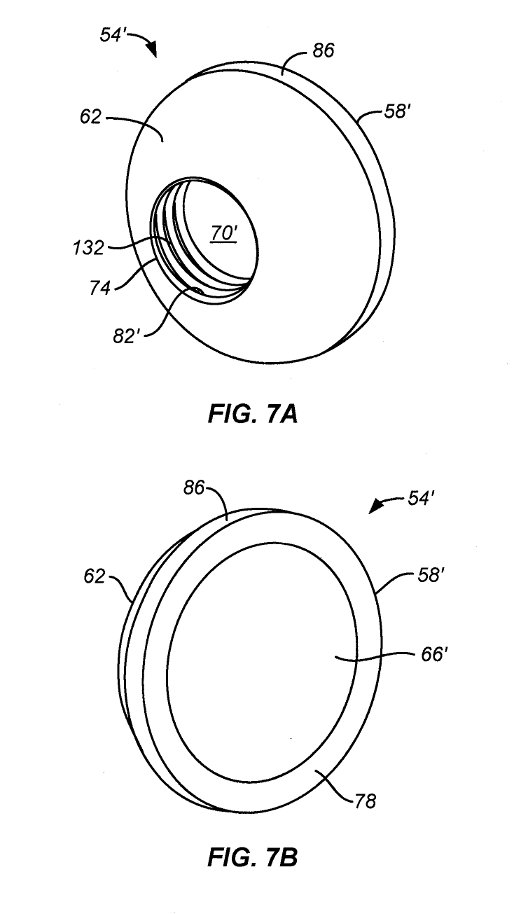

While the above is a description of various embodiments of inventive features, further modifications may be employed without departing from the spirit and scope of the present invention. For example, while inner transition surface 82 in the first embodiment was smooth, FIG. 7A shows an embodiment wherein an inner transition surface 82′ a force-distributing body 58′ of a force-distributing member 54′ forms, at least in part, a threaded inner peripheral surface 132 to form a threaded opening 70′ so that a threaded end of a spoke can be screwed directly into force-distributing body 58′. If desired, as shown in FIG. 7B, a modified second surface 66′ may partially or completely close off the rear of spoke-receiving opening 70. FIG. 7B shows second surface 66′ completely closing off the rear of spoke receiving opening 70 so that spoke receiving opening 70 is a blind opening, preferably with the threaded inner transition surface 82′ shown in FIG. 7A.

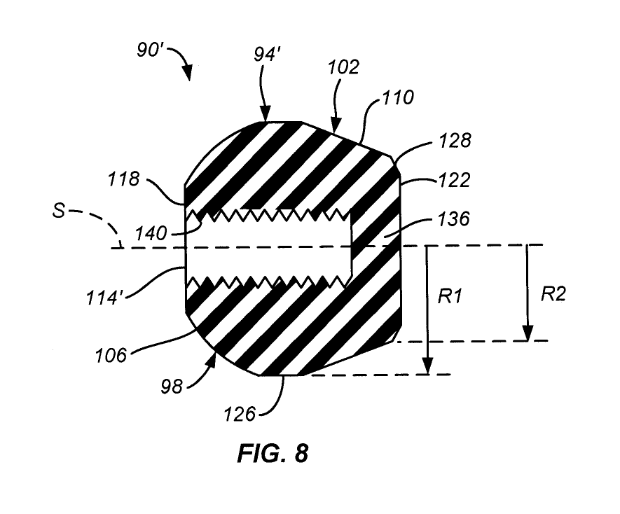

While spoke-receiving opening 114 in the second embodiment extended through both front edge 118 and rear edge 122 of force-distributing body 94 as shown in FIG. 5, FIG. 8 shows an embodiment of a force-distributing body 94′ wherein a rear wall 136 partially or completely closes off the rear of a spoke-receiving opening 114′. FIG. 8 shows rear wall 136 completely closing off the rear of spoke-receiving opening 114′ so that spoke-receiving opening 114′ is a blind opening. A threaded inner peripheral surface 140 is formed, at least in part, around spoke-receiving opening 114′ so that a threaded end of a spoke can be screwed directly into force-distributing body 94′.

The size, shape, location or orientation of the various components may be changed as desired. Components that are shown directly connected or contacting each other may have intermediate structures disposed between them. Separate components may be combined, and vice versa. The functions of one element may be performed by two, and vice versa. The function of one element may be performed by another, and functions may be interchanged among the elements. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Terms of degree such as “substantially,” “about” and “approximately” as used herein include a reasonable amount of deviation of the modified term such that the end result is not significantly changed. Thus, the scope of the invention should not be limited by the specific structures disclosed or the apparent initial focus or emphasis on a particular structure or feature.

What is claimed is:

1. A force distributing apparatus for a bicycle wheel spoke, wherein the apparatus comprises:
a force-distributing body having a free-end first surface and a second surface disposed at an opposite side of the first surface;
wherein the first surface has the shape of a truncated sphere; and
wherein the force-distributing body has a spoke-receiving opening that extends through the first surface.

2. The apparatus according to claim 1 wherein the force-distributing body has the shape of a truncated sphere.

3. The apparatus according to claim 2 wherein the first surface has the shape of a frustum of a sphere.

4. The apparatus according to claim 2 wherein the force-distributing body has the shape of a frustum of a sphere.

5. The apparatus according to claim 2 wherein the second surface has a concave shape.

6. The apparatus according to claim 5 wherein the second surface has the shape of a frustum of a sphere.

7. The apparatus according to claim 1 wherein the first surface is disposed on a first portion of the force-distributing body, wherein the second surface is disposed on a second portion of the force-distributing body, and wherein the spoke-receiving opening is disposed in the first portion to form a spoke-receiving axis.

8. The apparatus according to claim 7 wherein the second surface is tapered relative to the spoke-receiving axis.

9. The apparatus according to claim 8 wherein the second surface has a conical shape.

10. The apparatus according to claim 9 wherein the second surface has a shape of a truncated cone.

11. The apparatus according to claim 10 wherein the first surface has the shape of a frustum of a sphere.

12. The apparatus according to claim 1 wherein the spoke-receiving opening is a threaded opening.

13. The apparatus according to claim 12 wherein the spoke-receiving opening is a blind opening.

14. A force distributing apparatus for a bicycle wheel spoke, wherein the spoke is structured to be mounted to a hub flange of a bicycle wheel hub, wherein the hub flange includes an opening with a flange opening axis, and wherein the apparatus comprises:
a force-distributing body including:
a free-end first surface;
a second surface disposed at an opposite side of the first surface; and
a spoke-receiving opening;
wherein the first surface is structured to engage the hub flange when the spoke is mounted to the hub flange; and
wherein at least one of the first surface or the second surface is shaped to allow the spoke to move in any lateral direction relative to the flange opening axis.

15. The apparatus according to claim 14 wherein the first surface is shaped to allow the spoke to move in any lateral direction relative to the flange opening axis when the spoke is mounted to the hub flange.

16. The apparatus according to claim 14 wherein the second surface is shaped to allow the spoke to move in any lateral direction relative to the flange opening axis when the spoke is mounted to the hub flange.

17. The apparatus according to claim 14 wherein the first surface has the shape of a truncated sphere.

18. The apparatus according to claim 17 wherein the first surface has the shape of a frustum of a sphere.

19. The apparatus according to claim 17 wherein the force-distributing body has the shape of a frustum of a sphere.

20. The apparatus according to claim 17 wherein the second surface has a concave shape.

21. The apparatus according to claim 20 wherein the second surface has the shape of a frustum of a sphere.

22. The apparatus according to claim 14 wherein the first surface is disposed on a first portion of the force-distributing body, wherein the second surface is disposed on a second portion of the force-distributing body, and wherein the spoke-receiving opening extends through the first portion and through the second portion to form a spoke-receiving axis.

23. The apparatus according to claim 22 wherein the second surface is tapered relative to the spoke-receiving axis.

24. The apparatus according to claim 23 wherein the second surface has a conical shape.

25. The apparatus according to claim 24 wherein the second surface has a shape of a truncated cone.

26. The apparatus according to claim 25 wherein the first surface has the shape of a frustum of a sphere.

27. The apparatus according to claim 14 wherein the spoke-receiving opening is a threaded opening.

28. The apparatus according to claim 27 wherein the spoke-receiving opening is a blind opening.
